(19) United States
(12) Patent Application Publication
(10) Pub. No.: US 2013/0322330 A1
(43) Pub. Date: Dec. 5, 2013

(54) COMMUNICATION APPARATUS AND METHOD FOR GROUP MOVING OBJECT IN COMMUNICATION SYSTEM

(71) Applicant: ELECTRONICS AND TELECOMMUNICATIONS RESEARCH INSTITUTE, Daejeon (KR)

(72) Inventors: Bong-Su KIM, Daejeon (KR); Kwang-Seon KIM, Daejeon (KR); Min-Soo KANG, Daejeon (KR); Woo-Jin BYUN, Daejeon (KR)

(73) Assignee: Electronics And Telecommunications Research Institute, Daejeon (KR)

(21) Appl. No.: 13/712,185

(22) Filed: Dec. 12, 2012

(30) Foreign Application Priority Data
Jun. 1, 2012 (KR) 10-2012-0059184

(51) Int. Cl. H04W 16/00

(52) U.S. Cl. CPC H04W 16/00
USPC 370/328

(57) ABSTRACT

A communication apparatus for a group moving object in a communication system includes a Radio Frequency (RF) transmission/reception unit configured to simultaneously set up links with two or more Base Stations (BSs) placed on right and left sides of a road or a track, a baseband unit configured to perform baseband signal processing on signals transmitted and received through the RF transmission/reception unit, and a network interface unit connected to the baseband unit and configured to establish an Ethernet connection for providing communication service to devices within the group moving object.

### CROSS-REFERENCE TO RELATED APPLICATIONS

The present application claims priority of Korean Patent Application No. 10-2012-0059184, filed on Jun. 1, 2012, which is incorporated herein by reference in its entirety.

### BACKGROUND OF THE INVENTION

1. Field of the Invention

Exemplary embodiments of the present invention relate to a communication system and, more particularly, to a communication apparatus and method for a group moving object, which enable data to be transmitted at a high speed between a group moving object that moves at a high speed and a Base Station (BS) on the ground.

2. Description of Related Art

With the recent evolution of a communication system, the spread of user devices, such as smart phones and tablet PCs, is increasing. Thus, users' demands for using the Internet through the user devices anywhere and at any time are rapidly increasing. However, there are lots of places where high-speed wireless Internet is not supported, and one of the places is a group moving object (e.g., a train) that moves at a high speed.

In this group moving object, low-speed communication is provided through mobile communication technology. There is a problem in that the low-speed communication cannot satisfy an explosive demand for data.

### SUMMARY OF THE INVENTION

An embodiment of the present invention is directed to providing a high-speed communication apparatus and method for a group moving object, which can support high-speed data communication within the group moving object in a communication system.

Another embodiment of the present invention is directed to providing a communication apparatus and method for a group moving object, which have stable communication performance in a communication system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a communication apparatus for a group moving object in a communication system includes a Radio Frequency (RF) transmission/reception unit configured to simultaneously set up links with two or more BSs placed on right and left sides of a road or a track; a baseband unit configured to perform baseband signal processing on signals transmitted and received through the RF transmission/reception unit; and a network interface unit connected to the baseband unit and configured to establish an Ethernet connection for providing communication service to devices within the group moving object.

In accordance with another embodiment of the present invention, a communication apparatus for a group moving object in a communication system includes a first Radio Frequency (RF) unit configured to set up a first link with BSs placed on a right side of a road or track; a second RF unit configured to set up a second link with BSs placed on a left side of the road or track; and a baseband unit configured to perform baseband signal processing on signals transmitted and received through the first RF unit and the second RF unit.

In accordance with another embodiment of the present invention, a communication method for a group moving object in a communication system includes setting up links with two or more BSs placed on right and left sides of a road or track; establishing an Ethernet connection for providing communication service to devices within the group moving object through the links; and continuing to maintain links set up with two or more of a plurality of the BSs placed on the right and left sides of the road or track in zigzags when the group moving object moves.

### BRIEF DESCRIPTION OF THE DRAWINGS

FIG. 1 is a schematic diagram showing the configuration of a communication system including a train communication apparatus in accordance with an embodiment of the present invention.

FIG. 2 is a schematic diagram showing the deployment of BSs which communicate with a train in the communication system in accordance with an embodiment of the present invention.

FIG. 3 is a schematic diagram showing a construction of the train communication apparatus in the communication system in accordance with an embodiment of the present invention.

FIG. 4 is a schematic diagram showing the application of the train communication apparatus to a train in the communication system in accordance with an embodiment of the present invention.

FIG. 5 is a schematic diagram showing a construction of the train communication apparatus in the communication system in accordance with another embodiment of the present invention.

FIG. 6 is a schematic diagram showing the application of the train communication apparatus to a train in the communication system in accordance with another embodiment of the present invention.

FIG. 7 is a schematic diagram showing the operation of the train communication apparatus in the communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention proposes a communication apparatus and method for a group moving object which receive communication service in a communication system, for example, within the group moving object. In the following embodiments of the present invention, a train communication apparatus applied to a train is described as an example. It is however to be noted that the present invention is not limited to the train communication apparatus because the communication apparatus for a group moving object in accordance with the present invention can be applied not only a train, but also a group moving object in which several users can access data at the same time, such as a bus and a vehicle.

Hereinafter, it is assumed that the group moving object is a train. It is also assumed that BSs for providing communication service to a train can be placed on the right and left sides of the track (or the traveling direction) of a train in zigzags. The train communication apparatus of the present invention can be connected to two or more of the BSs placed in zigzags on the basis of the track (e.g., a road in a vehicle). For the connection with the BSs, the train communication apparatus of the present invention can be mounted on the train and configured to establish an Ethernet connection for providing communication service to user devices within the train.

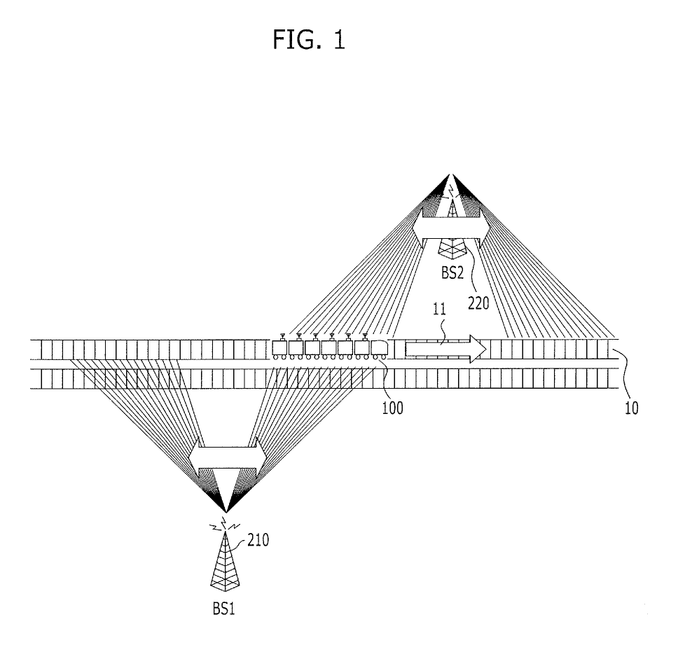

Meanwhile, an example in which the train communication apparatus of the present invention provides communication service that is robust to a rainfall using a microwave or millimeter wave band having a wide bandwidth in performing communication with a BS is described. However, the train communication apparatus of the present invention can provide communication service using bands other than the microwave or millimeter wave band. A communication system including a train communication apparatus in accordance with an embodiment of the present invention is described in detail below with reference to FIG. 1.

FIG. 1 is a schematic diagram showing the configuration of a communication system including a train communication apparatus in accordance with an embodiment of the present invention.

Referring to FIG. 1, the train communication system includes a train communication apparatus 100 and BSs 210 and 220.

The train communication apparatus 100 is mounted on a train. The train moves along a track 10, and the traveling direction 11 of the train is shown in the track 10. Here, the train can set up links with the first BS 210 placed on the right side of the train (or the traveling direction 11 of the train) and the second BS 220 placed on the left side thereof at the same time on the track 10. The train communication apparatus 100 includes antennas for communication with the BSs 210 and 220 and can set up links with the respective BSs 210 and 220 placed on the left and right sides of the train.

The BSs 210 and 220 are placed in zigzags on the basis of the track. Furthermore, each of the BSs 210 and 220 can track the train using an antenna tracking function having a predetermined length in order to maintain the link with the train that is moving. When the positions of the first BS 210 and the second BS 220 are 180° around the train, the best performance can be obtained. If the positions of the BSs 210 and 220 are limited depending on the installation of the BSs 210 and 220, however, the angular separation of each of the BSs 210 and 220 can be close to 180°. The BSs 210 and 220 can communicate with the train communication apparatus 100 using the millimeter wave band for high-speed data transmission of a Gigabit grade higher.

Communication using the millimeter wave band has a limited coverage due to rainfall attenuation. Accordingly, in communication systems that perform communication using the millimeter wave band, a rain rate and availability are specified. Rainfall analyses for reducing an influence due to the rainfall attenuation can reveal that the amount of rainfall has a non-uniform spatial distribution characteristic.

Thus, in the present invention, Cell Sight Diversity (CSD) technology for reducing an influence due to rainfall attenuation using the non-uniform spatial distribution characteristic is applied between the train communication apparatus 100 and the BSs 210 and 220. The CSD technology can improve the outage improvement probability of a link by reducing the influence of rainfall attenuation. Analyses into a heavy rainfall reveal that the amount of rainfall is locally concentrated. In the CSD technology, a principle that a greater gain can be obtained when setting up two or more links rather than when setting up one link can be used by taking a result of the analysis into consideration. Accordingly, the train communication apparatus 100 can perform communication using a signal having a greater gain from among signals received from the first BS 210 and the second. BS 220 in accordance with the CSD technology.

Meanwhile, the train communication apparatus 100 can establish an Ethernet connection for providing communication service to user devices within the train through the BSs 210 and 220. For example, the user device can include all types of devices to which communication service can be provided, such as a smart phone, a notebook, and a tablet PC.

Meanwhile, the CSD technology has a grater gain when an angular separation between links approaches 180°. The BSs 210 and 220 can be disposed so that the angular separation is close to 180°.

As described above, the train communication apparatus 100 proposed by the present invention can establish an Ethernet connection through the links set up with the BSs 210 and 220 for user devices within the train that moves at a high speed. Here, the train communication apparatus 100 can send Gigabit-grade data by communicating with the BSs 210 and 220 using the millimeter wave band capable of securing a wide bandwidth. Furthermore, the train communication apparatus 100 can maintain stable performance because it uses the CSD technology in order to prevent the deterioration of performance due to rainfall attenuation or signal distortion resulting from high-speed movement.

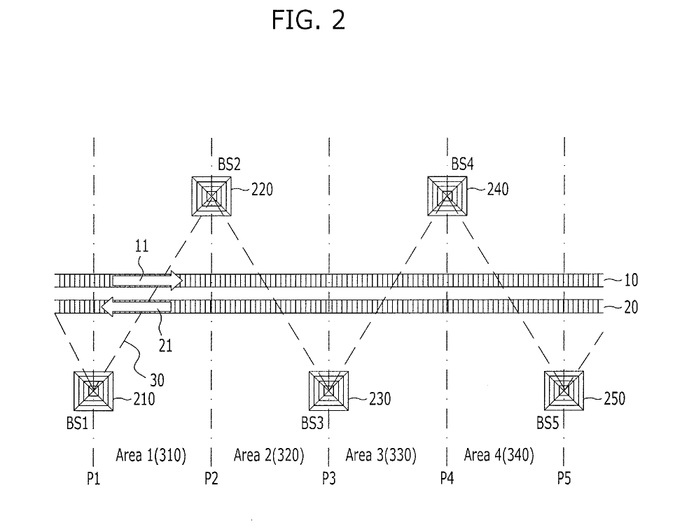

FIG. 2 is a schematic diagram showing the deployment of BSs which communicate with a train in the communication system in accordance with an embodiment of the present invention.

Referring to FIG. 2, first to fifth BSs 210, 220, 230, 240, and 250 can be deployed in a zigzag form 30 on the right and left sides of first and second tracks 10 and 20 in accordance with the CSD technology.

Here, the first to fifth BSs 210, 220, 230, 240, and 250 can form first to fourth regions 310, 320, 330, and 340 on the basis of first to fifth reference lines P1, P2, P3, P4, and P5 in a direction vertical to the first and the second tracks 10 and 20.

The first region 310 is placed between the first reference line P1 that centers on the first BS 210 and the second reference line P2 that centers on the second BS 220. The second region 320 is placed between the second reference line P2 that centers on the second BS 220 and the third reference line P3 that centers on the third BS 230. The third region 330 is placed between the third reference line P3 that centers on the third BS 230 and the fourth reference line P4 that centers on the fourth BS 240. Furthermore, the fourth region 340 is placed between the fourth reference line P4 that centers on the fourth BS 240 and the fifth reference line P5 that centers on the fifth BS 250.

Each of the BSs 210, 220, 230, 240, and 250 can be provided with information on the position of the train from adjacent BSs before the train reaches the BS. Accordingly, the BSs 210, 220, 230, 240, and 250 can be prepared to communicate with the train before the train reaches the BSs.

Here, it is assumed that a train to which the train communication apparatus 100 has been applied moves along the first track 10 in a first traveling direction 11. When the train is placed in the first region 310, the train communication apparatus 100 can set up links with the first BS 210 and the second BS 220 at the same time.

Before the train moves to the second region 320, the third BS 230 can receive information on the position of the train from an adjacent BS (e.g., the first BS 210 or the second BS 220). Thus, when the train enters the second region 320, the third BS 230 can set up a link with the train communication apparatus 100. When the train enters the second region 320, the first BS 210 disconnects the link with the train communication apparatus 100. Accordingly, when the train is placed in the second region 320, the train communication apparatus 100 can set up links with the second BS 220 and the third BS 230, respectively, at the same time.

Before the train moves to the third region 330, the fourth BS 240 can receive information on the position of the train from an adjacent BS (e.g., the second BS 220 or the third BS 230). Thus, when the train enters the third region 330, the fourth BS 240 can set up a link with the train communication apparatus 100. When the train enters the third region 330, the second BS 220 disconnects the link with the train communication apparatus 100. Accordingly, when the train is placed in the third region 330, the train communication apparatus 100 can set up links with the third BS 230 and the fourth BS 240 at the same time.

Furthermore, before the train moves to the fourth region 340, the fifth BS 250 can receive information on the position of the train from an adjacent BS (e.g., the third BS 230 or the fourth BS 240). Thus, when the train enters the fourth region 340, the fifth BS 250 can set up a link with the train communication apparatus 100. When the train enters the fourth region 340, the third BS 230 disconnects the link with the train communication apparatus 100. Accordingly, when the train is placed in the fourth region 340, the train communication apparatus 100 can set up links with the fourth BS 240 and the fifth BS 250 at the same time.

As described above, when the train is placed in the first traveling direction 11, the train communication apparatus 100 can set up a link with a BS at the next position.

In contrast, it is assumed that a train moves along the second track 20 in a second traveling direction 21. In this case, when the train is placed in the fourth region 340, the train communication apparatus 100 can set up links with the fourth BS 240 and the fifth BS 250 at the same time. When the train is placed in the third region 330, the train communication apparatus 100 can set up links with the third BS 230 and the fourth BS 240 at the same time. When the train is placed in the second region 320, the train communication apparatus 100 can set up links with the second BS 220 and the third BS 230 at the same time. Furthermore, when the train is placed in the first region 310, the train communication apparatus 100 can set up links with the first BS 210 and the second BS 220 at the same time.

Accordingly, the train communication apparatus 100 can continue to set up two or more links with BSs that are placed in the traveling direction of a train at the same time.

The train communication apparatus 100 can employ the CSD technology through the deployment of BSs. Accordingly, the train communication apparatus 100 can provide communication service to user devices through a BS having the greatest gain, from among BSs with which links have been set up.

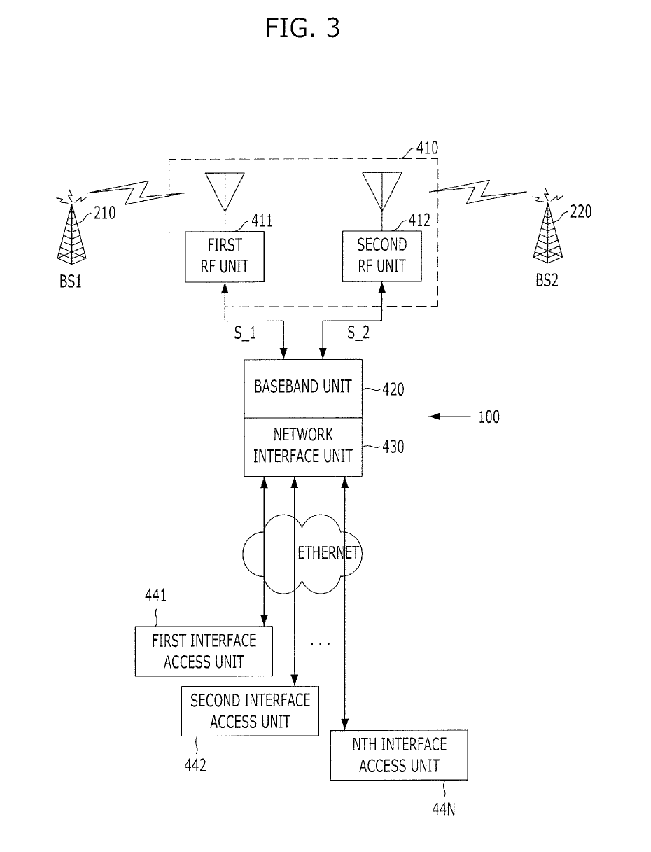

FIG. 3 is a schematic diagram showing a construction of the train communication apparatus in the communication system in accordance with an embodiment of the present invention.

Referring to FIG. 3, the train communication apparatus 100 includes a Radio Frequency (RF) transmission/reception unit 410, a baseband unit 420, a network interface unit 430, and a plurality of interface access units 441, 442 to 44N.

The train communication apparatus 100 set up links with, for example, the first BS 210 and the second BS 220 at the same time. This corresponds to the case where the train communication apparatus 100 is placed in the first region 310 in FIG. 2. Accordingly, the RF transmission/reception unit 410 communicates with the first BS 210 and the second BS 220 at the same time. The RF transmission/reception unit 410 includes a first RF unit 411 and a second RF unit 412.

The first RF unit 411 and the second RF unit 412 can include respective antennas for transmitting and receiving signals. Each of the first RF unit 411 and the second RF unit 412 modulates a signal received from the baseband unit 420, sends the modulated signal, demodulates a signal received through the antenna, and outputs the demodulated signal to the baseband unit 420.

The first RF unit 411 communicates with the first BS 210. The first RF unit 411 receives a first signal S_1 from the first BS 210. The first RF unit 411 demodulates the first signal S_1 and outputs the demodulated signal to the baseband unit 420.

Furthermore, the second RF unit 412 communicates with the second BS 220. The second RF unit 412 receives a second signal S_2 from the second BS 220. The second RF unit 412 demodulates the second signal S_2 outputs the demodulated signal to the baseband unit 420.

The baseband unit 420 can transmit and receive data to and from the BSs 210 and 220 through the RF transmission/reception unit 410. The baseband unit 420 converts a digital signal, received from the network interface unit 430, into an analog signal by performing baseband signal processing on the digital signal and outputs the converted analog signal to the RF transmission/reception unit 410. The baseband unit 420 converts an analog signal, received from the RF transmission/reception unit 410, into a digital signal by performing baseband signal processing on the analog signal and outputs the converted digital signal to the network interface unit 430.

The baseband unit 420 can select a signal having the greatest gain, from among signals received from the two or more BSs 210 and 220 in accordance with the CSD technology when it is connected to the RF units 411 and 412 having respective links set up with the two or more BSs 210 and 220. Furthermore, the baseband unit 420 can transmit and receive signals through a link set up with a BS having the greatest gain.

The network interface unit 430 is connected to the baseband unit 420 and is configured to form an Ethernet for providing communication service to user devices within the train. Here, the Ethernet can be, for example, a Gigabit Ethernet because it performs communication using the millimeter wave band having a wide bandwidth. Meanwhile, the network interface unit 430 is connected to the plurality of interface access units 441, 442 to 44N for connection with user devices within respective passenger cars.

The plurality of interface access units 441, 442 to 44N is connected to the network interface unit 430. The plurality of interface access units 441, 442 to 44N can be placed within the respective passenger cars for connection with user devices.

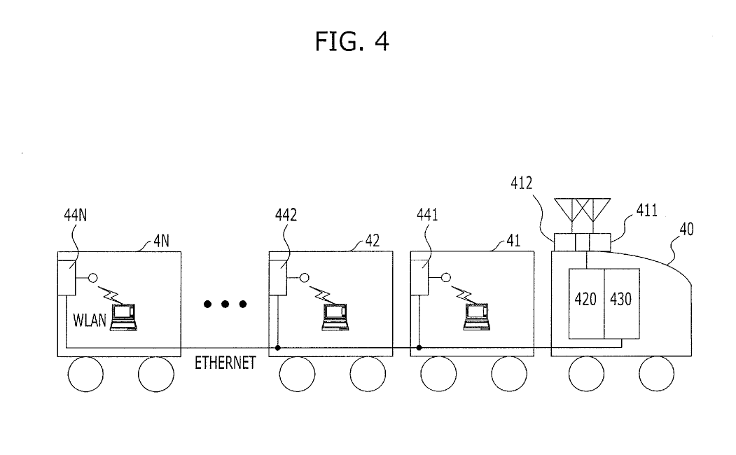

FIG. 4 is a schematic diagram showing the application of the train communication apparatus 100 to a train in the communication system in accordance with an embodiment of the present invention.

Referring to FIG. 4, the train can include a locomotive engine 40 and a plurality of passenger cars 41, 42 to 4N.

The first RF unit 411 and the second RF unit 412 are placed in the locomotive engine 40. Furthermore, the locomotive engine 40 includes the baseband unit 420 and the network interface unit 430.

The plurality of passenger cars 41, 42 to 4N can include the respective interface access units 441, 442 to 44N. For example, the first interface access unit 441 can be placed in the first passenger car 41, the second interface access unit 442 can be placed in the second passenger car 42, and the N^{th} interface access unit 44N can be placed in the N^{th} passenger car 4N.

Here, the interface access units 441, 442 to 44N can communicate with the user devices placed in the respective passenger cars 41, 42 to 4N and can provide, for example, a Wireless Local Area Network (WLAN).

Although the example in which the train communication apparatus 100 is applied to the train has been described, the RF units 411 and 412, the baseband unit 420, and the network interface unit 430 may be placed in any one of the plurality of passenger cars 41, 42 to 4N not the locomotive engine 40.

If the train communication apparatus 100 having the structures of FIGS. 3 and 4 is used, data can be transmitted at a high speed because a change of the exiting train communication apparatus is minimized.

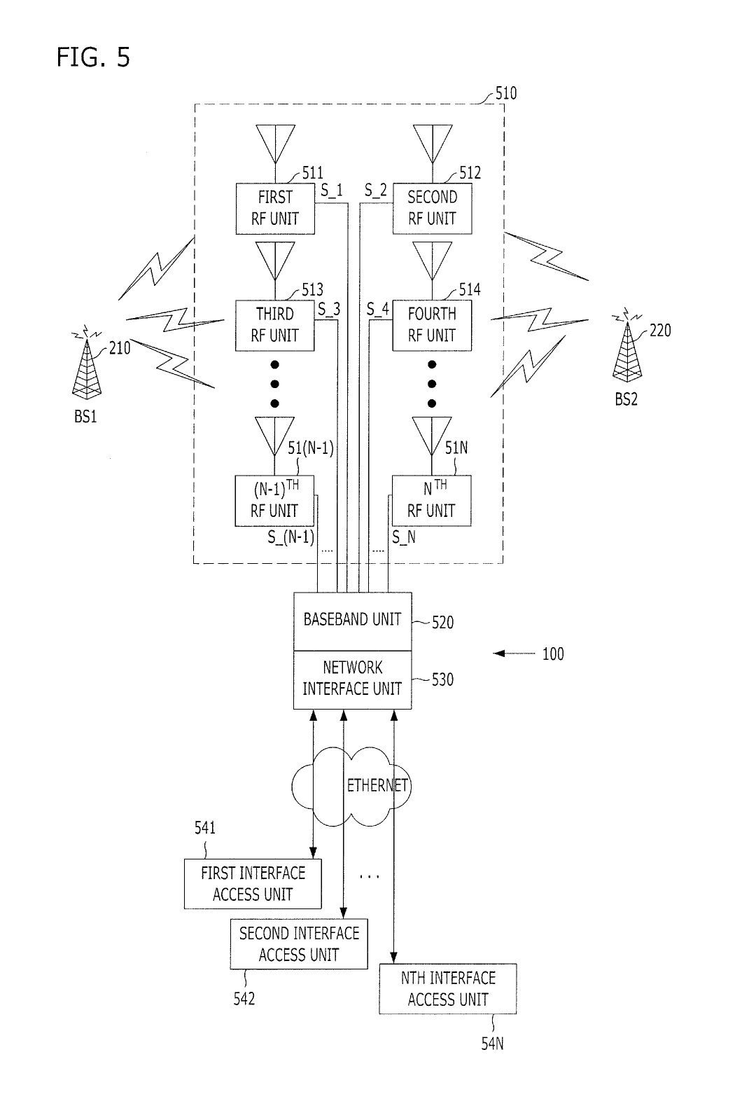

FIG. 5 is a schematic diagram showing a construction of the train communication apparatus 100 in the communication system in accordance with another embodiment of the present invention.

Referring to FIG. 5, the train communication apparatus 100 includes an RF transmission/reception unit 510, a baseband unit 520, a network interface unit 530, and a plurality of interface access units 541, 542 to 54N.

The RF transmission/reception unit 510 includes a plurality of RF units 511, 512, 513, 514 to 51(N-1), and 51N.

The plurality of RF units 511, 512, 513, 514 to 51(N-1), and 51N can include respective antennas for transmitting and receiving signals. The plurality of RF units 511, 512, 513, 514 to 51(N-1), and 51N modulates signals received from the baseband unit 520, sends the modulated signals, demodulates signals received through the antennas, and outputs the demodulated signals to the baseband unit 520.

The first RF unit 511, the third RF unit 513 to the (N-1)^{th} RF unit 51(N-1) receive a first signal S_1, a third signal S_3 to an (N-1)^{th} RF signal S_(N-1), respectively, from the first BS 210, demodulate the signals, and output the demodulated signals to the baseband unit 520.

Furthermore, the second RF unit 512, the fourth RF unit 514 to the N^{th} RF unit 51N receive a second signal S_2, a fourth signal S_4 to an N^{th} signal S_N, respectively, from the second BS 220, demodulate the signals, and output the demodulated signals to the baseband unit 520.

Therefore, the first RF unit 511, the third RF unit 513 to the (N-1)^{th} RF unit 51(N-1) direct their antennas towards the first BS 210 when links with the first BS 210 are set up. In contrast, the second RF unit 512, the fourth RF unit 514 to the N^{th} RF unit 51N direct their antennas towards the second BS 220 when links with the second BS 220 are set up.

Here, the baseband unit 520 can use the plurality of antennas of the RF transmission/reception unit 510 that communicates with the BSs 210 and 220 in accordance with Multiple Input Multiple Output (hereinafter referred to as ‘MIMO’) antenna technology using. In the MIMO technology, a communication capacity can be increased depending on the number of antennas used through multiple inputs and outputs for signals using a plurality of antenna. To this end, the RF transmission/reception unit 510 can include N antennas.

1:(N/2) MIMO technology can be applied to the baseband unit 520 because the baseband unit 520 sets up a link with one BS using (N/2) antennas. The baseband unit 520 uses signals having a greater gain, from among the signals of two BSs in accordance with the CSD technology.

In some embodiments, 2:N MIMO technology can be applied to the baseband unit 520 because the baseband unit 520 sets up links with two BSs using N antennas. It is assumed that the baseband unit 520 is placed in an environment in which all signals received through the RF transmission/reception unit 510 have different delay times and signal intensities.

The train communication apparatus 100 of FIG. 5 has a similar construction to the train communication apparatus 100 of FIG. 3 other than the RF transmission/reception unit 510 and the baseband unit 520, and thus reference can be made to FIG. 3 for a detailed description of the remaining elements.

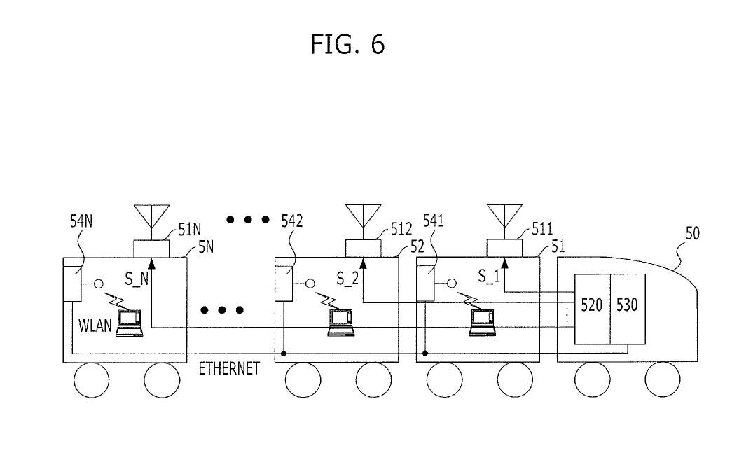

FIG. 6 is a schematic diagram showing the application of the train communication apparatus 100 to a train in the communication system in accordance with another embodiment of the present invention.

Referring to FIG. 6, the train can include a locomotive engine 50 and a plurality of passenger cars 51, 52 to 5N.

The first RF unit 511 is placed in the first passenger car 51, the second RF unit 512 is placed in the second passenger car 52, and the N^{th} RF unit 51N is placed in the N^{th} passenger car 5N. Here, the RF units 511, 513 to 51(N-1) that communicate with the first BS 210 and the RF units 512, 514 to 51N that communicate with the second BS 220 can be alternately placed in the plurality of passenger cars.

Furthermore, the locomotive engine 50 includes the baseband unit 520 and the network interface unit 530.

The plurality of passenger cars 51, 52 to 5N can include the respective interface access units 541, 542 to 54N. For example, the first interface access unit 541 is placed in the first passenger car 51, the second interface access unit 542 is placed in the second passenger car 52, and the N^{th} interface access unit 54N is placed in the N^{th} passenger car 5N.

Here, the interface access units 541, 542 to 54N communicate with user devices placed in the respective passenger cars 51, 52 to 5N and can provide, for example, a WLAN.

Although the example in which the train communication apparatus 100 is applied to the train has been described, the baseband unit 520 and the network interface unit 530 may be placed in any one of the plurality of passenger cars 51, 52 to 5N not the locomotive engine 50. Furthermore, the RF units 511, 512 to 51N may be placed in some of the passenger cars or a plurality of the RF units may be placed in one of the passenger cars.

If the train communication apparatus 100 having the structure of FIGS. 5 and 6 is used, signal transmission and reception performance can be improved using a plurality of antennas (MIMO technology).

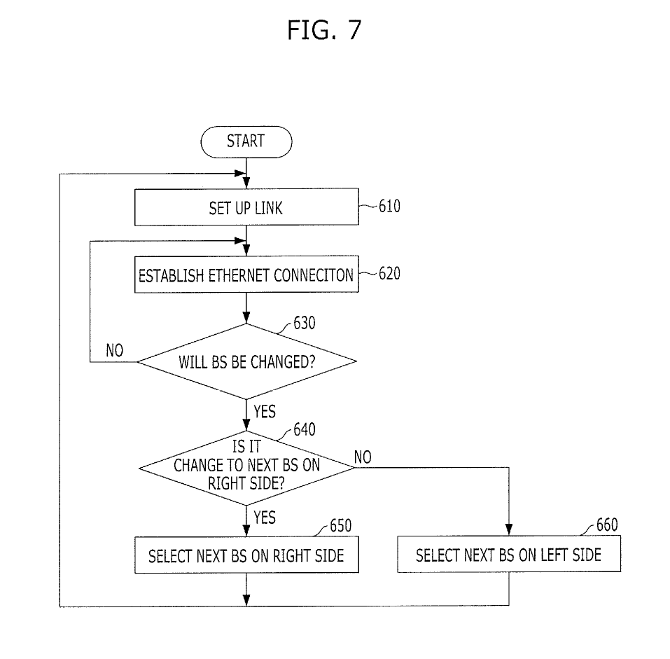

FIG. 7 is a schematic diagram showing the operation of the train communication apparatus in the communication system in accordance with an embodiment of the present invention.

Referring to FIG. 7, at step 610, the train communication apparatus 100 can set up links with two or more BSs placed near a track. The train communication apparatus 100 can use two or more antennas that are directed towards the two or more BSs, respectively.

At step 620, the train communication apparatus 100 can establish an Ethernet connection through the transmission and reception of signals to and from the two or more BSs. Accordingly, the train communication apparatus 100 can provide communication service to user devices within a corresponding train. Here, the train communication apparatus 100 can use the CSD technology. Furthermore, if two or more antennas have set up links with two or more BSs, respectively, the train communication apparatus 100 can use MIMO technology.

At step 630, the train communication apparatus 100 determines whether or not to change a BS as the train moves. If, as a result of the determination, the train communication apparatus 100 determines not to change the BS, the train communication apparatus 100 proceeds to the step 620. At the step 620, the train communication apparatus 100 continues to perform communication with the BSs. If, as a result of the determination, however, the train communication apparatus 100 determines to change the BS, the train communication apparatus 100 proceeds to step 640.

At the step 640, the train communication apparatus 100 determines whether the change is a change to a next BS placed on the right side or not. If, as a result of the determination, it is determined that the change is a change to a next BS placed on the right side, the train communication apparatus 100 proceeds to step 650.

At the step 650, the train communication apparatus 100 selects the next BS placed on the right side in the traveling direction of the train. Next, the train communication apparatus 100 proceeds to the step 610 in which it continues to set up with two or more BSs through the link set up with the selected BS placed on the right side.

If, as a result of the determination, however, it is determined that the change is not a change to a next BS placed on the right side, the train communication apparatus 100 proceeds to step 660.

At the step 660, the train communication apparatus 100 selects a next BS placed on the left side in the traveling direction of the train. Next, the train communication apparatus 100 proceeds to the step 610 in which it continues to set up with two or more BSs through the link set up with the selected BS placed on the left side.

In accordance with the operation, the train communication apparatus 100 can provide communication service to user devices within a train as the train moves. Here, the train communication apparatus 100 can provide Gigabit-grade communication to user devices within a moving train through communication using a millimeter wave.

The train communication apparatus of the present invention enables Gigabit-grade data transmission using the millimeter wave band having a wide bandwidth even in a train that moves at a high speed. Furthermore, the present invention proposes the deployment of a cell which can effectively reduce a loss due to rainfall attenuation. In this case, a loss due to rainfall attenuation can be reduced through the cell deployment because the train communication apparatus uses the CSD technology. Furthermore, the train communication apparatus can use MIMO technology because it sends data using a plurality of RF units. Here, the train communication apparatus can use 1:(N/2) MIMO technology or 2:N MIMO technology and provide stable performance to a system.

The present invention is advantageous in that it can support high-speed data communication because a communication apparatus for a group moving object, moving in a communication system, communicates with BSs placed near a road or track using a microwave or millimeter wave band.

In particular, the present invention is advantageous in that it can reduce a loss due to rainfall attenuation because it uses signals from a plurality of BSs using the CSD technology.

While the present invention has been described with respect to the specific embodiments, it will be apparent to those skilled in the art that various changes and modifications may be made without departing from the spirit and scope of the invention as defined in the following claims.

What is claimed is:

1. A communication apparatus for a group moving object in a communication system, comprising:
a Radio Frequency (RF) transmission/reception unit configured to simultaneously set up links with two or more Base Stations (BSs) placed on right and left sides of a road or a track;
a baseband unit configured to perform baseband signal processing on signals transmitted and received through the RF transmission/reception unit; and
a network interface unit connected to the baseband unit and configured to establish an Ethernet connection for providing communication service to devices within the group moving object.

2. The communication apparatus of claim 1, wherein the RF transmission/reception unit comprises antennas directed towards a plurality of the BSs placed on the right and left sides of the road or the track in zigzags.

3. The communication apparatus of claim 2, wherein the RF transmission/reception unit comprises:
one or more first RF units configured to comprise one or more antennas directed towards the BS placed on the right side and configured to set up links with the BS on the right side; and
one or more second RF units configured to comprise one or more antennas directed towards the BS placed on the left side and configured to set up links with the BS on the left side.

4. The communication apparatus of claim 3, wherein when a number of each of the first RF units and the second RF units is two or more, communication is performed using a Multiple Input Multiple Output (MIMO) method.

5. The communication apparatus of claim 1, wherein the RF transmission/reception unit sets up the links using a microwave or millimeter wave band.

6. The communication apparatus of claim 1, wherein the baseband unit selects a signal having a greatest gain from signals received from the two or more BSs, respectively, according to Cell Sight Diversity (CSD) technology.

7. The communication apparatus of claim 1, further comprising a plurality of interface access units connected to the network interface unit and configured to communicate with the devices within the group moving object.

8. The communication apparatus of claim 7, wherein the plurality of interface access units is placed in respective passenger cars of a train.

9. A communication apparatus for a group moving object in a communication system, comprising:
a first Radio Frequency (RF) unit configured to set up a first link with Base Stations (BSs) placed on a right side of a road or track;
a second RF unit configured to set up a second link with BSs placed on a left side of the road or track; and
a baseband unit configured to perform baseband signal processing on signals transmitted and received through the first RF unit and the second RF unit.

10. The communication apparatus of claim 9, wherein the first RF unit and the second RF unit set up the first link and the second link, respectively, using a microwave or millimeter wave band.

11. The communication apparatus of claim 9, wherein the first RE unit comprises an antenna directed towards the BS placed on the right side, from among the plurality of BSs placed on the right and left sides of the road or the track in zigzags.

12. The communication apparatus of claim 9, wherein the second RF unit comprises an antenna directed towards the BS placed on the left side, from among the plurality of BSs placed on the right and left sides of the road or the track in zigzags.

13. The communication apparatus of claim 9, wherein the baseband unit selects a signal having a greatest gain from signals received through the first link and the second link.

14. The communication apparatus of claim 9, wherein when each of the first RF unit and the second RF unit comprises two or more antennas, communication is performed using a Multiple Input Multiple Output (MIMO) method.

15. The communication apparatus of claim 9, further comprising:
a network interface unit connected to the baseband unit and configured to establish an Ethernet connection for providing communication service to devices within the group moving object; and
a plurality of interface access units connected to the network interface unit and configured to communicate with the devices within the group moving object.

16. A communication method for a group moving object in a communication system, comprising:
setting up links with two or more Base Stations (BSs) placed on right and left sides of a road or track;
establishing an Ethernet connection for providing communication service to devices within the group moving object through the links; and
continuing to maintain links set up with two or more of a plurality of the BSs placed on the right and left sides of the road or track in zigzags when the group moving object moves.

17. The communication method of claim 16, wherein in said setting up links with two or more Base Stations (BSs) placed on right and left sides of a road or track,
the links are set up using a Multiple Input Multiple Output (MIMO) method using two or more antennas for each of the left side and the right side.

18. The communication method of claim 16, wherein in said establishing an Ethernet connection for providing communication service to devices within the group moving object through the links,
a signal having a greatest gain is selected from signals received from the two or more BSs, respectively, according to Cell Sight Diversity (CSD) technology.
